(19) United States
(12) Patent Application Publication
(10) Pub. No.: US 2018/0033541 A1
(43) Pub. Date: Feb. 1, 2018

(54) COIL COMPONENT AND METHOD OF MANUFACTURING THE SAME

(71) Applicant: SAMSUNG ELECTRO-MECHANICS CO., LTD., Suwon-si (KR)

(72) Inventors: Seok Il HONG, Suwon-si (KR); Ju Hwan YANG, Suwon-si (KR); Young Seuck YOO, Suwon-si (KR); Won Chul SIM, Suwon-si (KR)

(21) Appl. No.: 15/485,617

(22) Filed: Apr. 12, 2017

(30) Foreign Application Priority Data
Jul. 28, 2016 (KR) 10-2016-0096197

(51) Int. Cl. H01F 27/28; H01F 41/12; H01F 41/04; H01F 41/02; H01F 27/245; H01F 27/32

(52) U.S. Cl. CPC H01F 27/2804; H01F 27/245; H01F 27/323; H01F 41/041; H01F 41/0233; H01F 41/122; H01F 2027/2809

(57) ABSTRACT

A coil component includes a coil part having a through hole in a center, including a coil covered by an insulating film, and having a first surface and a second surface opposing each other, a core disposed in the through hole and including a nonmagnetic layer, and cover portions disposed on the first surface and the second surface of the coil part.

### CROSS-REFERENCE TO RELATED APPLICATION

This application claims the benefit of priority to Korean Patent Application No. 10-2016-0096197, filed on Jul. 28, 2016 with the Korean Intellectual Property Office, the entire disclosure of which is incorporated herein by reference.

### BACKGROUND

### 1. Technical Field

The present disclosure relates to a coil component and a method of manufacturing the same.

### 2. Description of Related Art

An inductor, a type of coil component, may be combined with a capacitor to configure a resonance circuit, a filter circuit, or the like, for amplifying a signal within a specific frequency band, or as a typical passive component for removing noise while forming an electronic circuit together with a resistor and a capacitor.

In recent years, the miniaturization and thinning of information technology (IT) devices, such as communications devices and display devices, have been accelerated. Research has been continuously carried out into the miniaturization and thinning of various devices applied to such IT devices, such as inductors, capacitors, transistors, and the like.

Despite such miniaturization, the level of performance required of a coil component is the same or slightly increased. In an inductor, a coil component, characteristics such as capacitance, direct current superposition characteristics, loss efficiency, and the like are considered important.

To improve characteristics of a coil component, a coil having a plurality of layers is provided. As a coil having a plurality of layers is provided, an aspect ratio of a core located in the center of a coil part is increased.

Generally, a core is formed in such a manner that a through hole is formed in the center of a coil part and the through hole is filled with a magnetic material. In this case, when an aspect ratio of a core is increased, a problem in which filling of the through hole is limited may occur.

Due to a high aspect ratio, when an unfilled region is generated in a through hole, a reduction in characteristics of a coil component may occur.

Therefore, it is necessary to prevent a reduction in characteristics of a coil component and to provide a coil component that may maintain a uniform level of performance by reducing a rate of a change in an inductance value L with respect to using current and temperature.

### SUMMARY

An aspect of the present disclosure provides a coil component including a nonmagnetic layer disposed in a core.

Another aspect of the present disclosure provides a method of manufacturing a coil component for efficiently manufacturing a coil component including a nonmagnetic layer disposed in a core.

According to an aspect of the present disclosure, a coil component includes: a coil part having a through hole in a center, including a coil surrounded by an insulating film, and having a first surface and a second surface opposing each other; a core disposed in the through hole and including a nonmagnetic layer; and cover portions disposed on the first surface and the second surface of the coil part.

According to another aspect of the present disclosure, a method of manufacturing a coil component includes: preparing a coil part having a through hole in a center, including a coil surrounded by an insulating film, and having a first surface and a second surface opposing each other, preparing a first magnetic sheet and a second magnetic sheet containing a magnetic particle, pressing the first magnetic sheet onto the first surface of the coil part to fill a portion of the through hole, and pressing the second magnetic sheet onto the second surface of the coil part to fill an unfilled region of the through hole.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic cross-sectional view of a coil component according to an exemplary embodiment;

FIG. 2 is an image of a cross section of a coil component according to an exemplary embodiment, captured by an electron microscope;

FIG. 3 is a schematic cross-sectional view of a coil component according to another exemplary embodiment;

FIG. 4 is a flow chart of a method of manufacturing a coil component according to a different exemplary embodiment; and

FIGS. 5 to 8 are schematic cross-sectional views illustrating operations in a method of manufacturing a coil component according to a different exemplary embodiment.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on, ” “directly connected to,” or “directly coupled to” another element, there may be no other elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship relative to another element(s) as shown in the figures. It will be understood that the spatially relative terms are intended to encompass different orientations of the device in use or operation in addition to the orientation depicted in the figures.

For example, if the device in the figures is turned over, elements described as “above,” or “upper” relative to other elements would then be oriented “below,” or “lower” relative to the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present disclosure will be described with reference to schematic views illustrating embodiments of the present disclosure. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape results in manufacturing. The following embodiments may also be constituted by one or a combination thereof.

The contents of the present disclosure described below may have a variety of configurations and propose only a required configuration herein, but are not limited thereto.

Coil Component

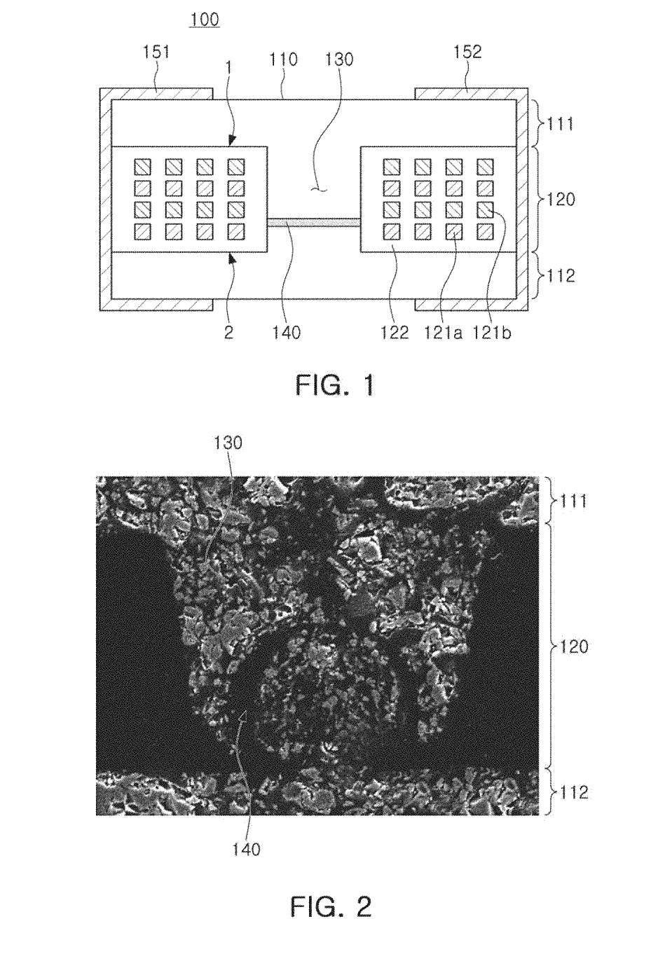

FIG. 1 is a schematic cross-sectional view of a coil component 100 according to an exemplary embodiment.

With reference to FIG. 1, the coil component 100 according to an exemplary embodiment may include a body 110, as well as external electrodes 151 and 152 disposed on first and second end surfaces of the body in a longitudinal direction.

The body 110 may include a coil part 120, as well as a first cover portion 111 and a second cover portion 112 disposed on a first surface 1 and a second surface 2 of the coil part 120, respectively.

Since the first cover portion 111 and the second cover portion 112 are formed by pressing a magnetic sheet, magnetic flux may flow in the first cover portion 111 and the second cover portion 112.

The body 110 may form an exterior of the coil component 100, and may be formed of any material having magnetic properties without limitation.

The material having magnetic properties may be a ferrite powder or a magnetic metal powder.

The ferrite powder may be formed of Mn—Zn-based ferrite, Ni—Zn-based ferrite, Ni—Zn—Cu-based ferrite, Mn—Mg-based ferrite, Ba-based ferrite, Li-based ferrite, or the like.

The magnetic metal powder may include at least one selected from the group consisting of iron (Fe), silicon (Si), chromium (Cr), aluminum (Al), and nickel (Ni), and may be, for example, an Fe—Si—B—Cr-based amorphous metal, but an exemplary embodiment is not limited thereto.

A particle diameter of the ferrite powder or the magnetic metal powder may be 0.1 μm to 30 μm, and the ferrite powder or the magnetic metal powder may be included in the form in which the ferrite powder or the magnetic metal powder is dispersed in thermosetting resin such as epoxy resin, or the like.

The coil part 120 may include a coil having one or more layers.

For example, the coil part 120 may include a first coil 121a and a second coil 121b.

When the coil part 120 includes the first coil 121a and the second coil 121b, the coil component 100 may be used as a common mode filter.

When the first coil 121a and the second coil 121b have a plurality of layers, coils located in different layers may be electrically connected to each other by a conductive via (not shown) as required.

In addition, one end of the first coil 121a and one end of the second coil 121b may be exposed to an exterior of the body 110 to be electrically connected to the external electrodes 151 and 152, respectively.

The first coil 121a and the second coil 121b may be coated with an insulating film 122.

The insulating film 122 may be formed using a method such as a screen printing, a process of exposure and development of a photoresist, a spray coating process, or the like.

Since the first coil 121a and the second coil 121b are coated with the insulating film 122, the first coil and the second coil may be electrically insulated from a magnetic material forming the body 110.

The first coil 121a and the second coil 121b may be formed of silver (Ag) or copper (Cu). The first coil 121a and the second coil 121b may be formed by spirally printing conductive paste on a magnetic sheet, or by plating.

A core 130 may be disposed in a center of the coil part 120, that is, in a through hole.

The core 130 may be formed by pressing a magnetic sheet containing a magnetic particle onto the through hole passing from the first surface 1 of the coil part 120 to the second surface 2 thereof.

A nonmagnetic layer 140 may be disposed inside of the core 130. The nonmagnetic layer 140 may only be disposed inside the core 130.

When a first magnetic sheet and a second magnetic sheet are pressed to form the core 130, the nonmagnetic layer 140 may be formed in a location in which a first magnetic sheet is in contact with a second magnetic sheet. In other words, when the first magnetic sheet and the second magnetic sheet are pressed, since fluidity of epoxy resin, or the like, is higher than fluidity of a magnetic particle, the nonmagnetic layer 140 not containing a magnetic particle may be formed in the location in which the first magnetic sheet is in contact with the second magnetic sheet.

For example, the nonmagnetic layer 140 may be an epoxy layer.

Since the coil component 100 according to an exemplary embodiment includes the nonmagnetic layer 140 disposed in the core 130, a portion of magnetic flux may be blocked, to reduce a rate of change in an inductance value L due to change in current, thereby maintaining a uniform level of performance.

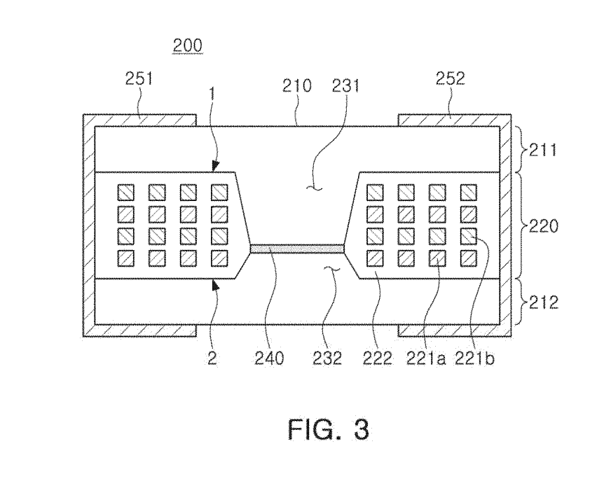

FIG. 2 is an image of a cross section of the coil component 100 according to an exemplary embodiment, captured by an electron microscope.

With reference to FIG. 2, it is confirmed that the nonmagnetic layer 140 in which magnetic powder particles are not disposed inside of the core 130 is formed. A shape of the nonmagnetic layer 140 may be linear, but an exemplary embodiment is not limited thereto. Alternatively, as illustrated in FIG. 2, the shape of the nonmagnetic layer may be curved or circular.

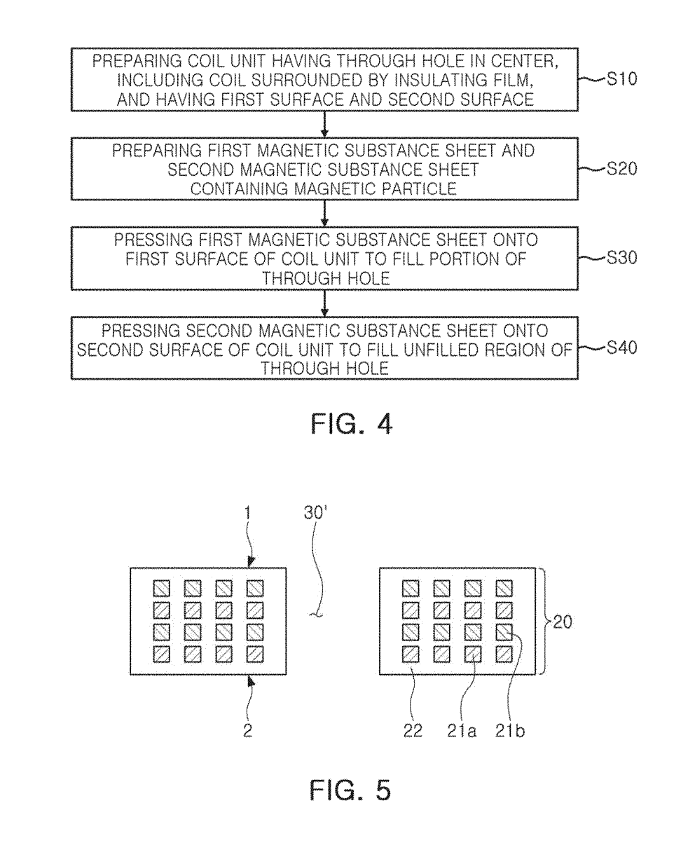

FIG. 3 is a schematic cross-sectional view of a coil component 200 according to another exemplary embodiment.

A description of a configuration the same as or similar to the configuration described above will be omitted.

With reference to FIG. 3, cores 231 and 232 according to the present exemplary embodiment may include a first core 231 whose width is gradually narrowed from the first surface 1 of a coil part 220 toward the second surface 2 thereof, and a second core 232 whose width is gradually narrowed from the second surface 2 of the coil part 220 toward the first surface 1 thereof.

When a through hole for formation of a core is formed in the coil part 220, the through hole is not formed only a single surface of the first surface 1 or the second surface 2 of the coil part 220, but in each of both surfaces of the coil part 220. After the through hole is formed to allow each through hole to be connected to each other, the through hole is filled with a first magnetic sheet and a second magnetic sheet to form the first core 231 and the second core 232.

When an aspect ratio of a core is increased above a predetermined value, it becomes further difficult to form the core by filling the through hole.

However, in a manner the same as the coil component 200 according to another exemplary embodiment, when the first core 231 and the second core 232 are formed, the through hole may be easily filled with a magnetic material.

In addition, a nonmagnetic layer 240 may be formed in a location in which the first core 231 is in contact with the second core 232.

Method of Manufacturing a Coil Component

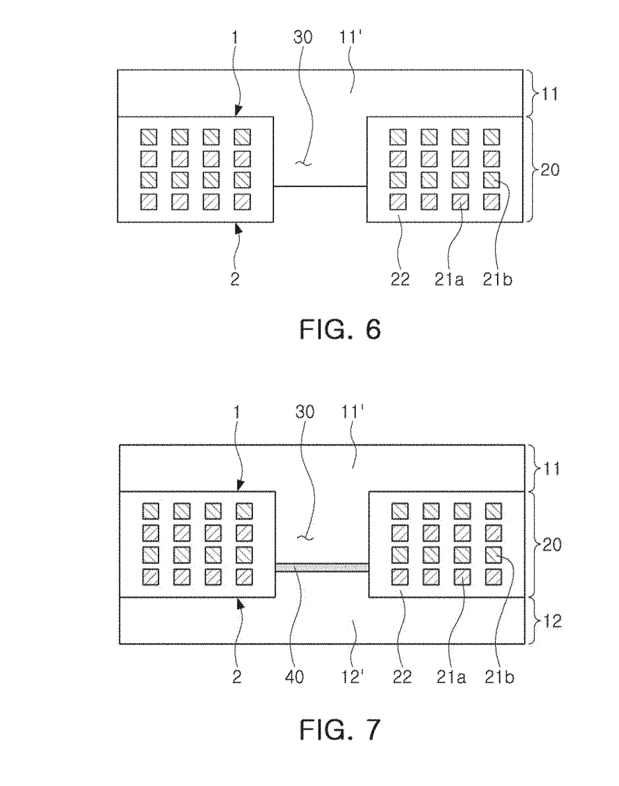

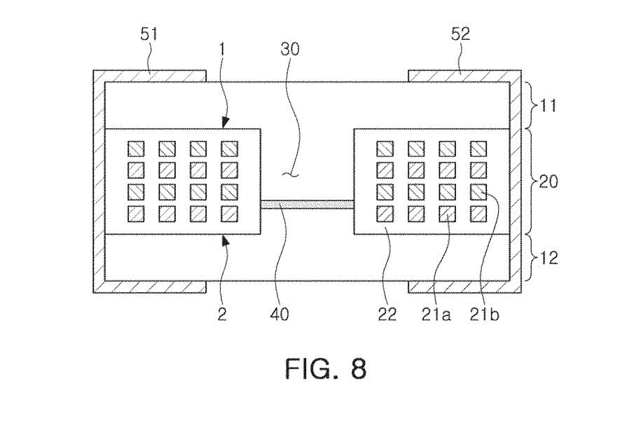

FIG. 4 is a flow chart illustrating a method of manufacturing a coil component according to a different exemplary embodiment, and FIGS. 5 to 8 are schematic cross-sectional views illustrating operations in the method of manufacturing a coil component according to a different exemplary embodiment.

Hereinafter, with reference to FIG. 4 and FIGS. 5 to 8, the method of manufacturing a coil component according to the present exemplary embodiment will be described.

First, as illustrated in FIG. 5, an operation S10 of preparing a coil part 20 having a through hole 30′ in a center, including coils 21a and 21b surrounded by an insulating film 22, and having a first surface 1 and a second surface 2, is performed.

The through hole 30′ may be formed using mechanical drilling or laser drilling, but an exemplary embodiment is not limited thereto. For example, the laser drill may be a CO₂ laser or a YAG laser.

The through hole 30′, as illustrated in FIG. 3, may include a first through hole whose width is gradually narrowed from the first surface 1 of the coil part 20 toward the second surface 2 thereof, and a second through hole whose width is gradually narrowed from the second surface 2 of the coil part 20 toward the first surface 1 thereof.

The coils 21a and 21b may be formed using conductive metal such as silver (Ag), copper (Cu), or the like. For a method of forming the coils 21a and 21b, after the coils 21a and 21b are formed by printing conductive paste on a magnetic sheet or plating, the coils 21a and 21b may be encapsulated by the insulating film 22.

The coils 21a and 21b may be a plurality of layers or a plurality of coils, as required.

For example, when the coil component is a common mode filter, the coils 21a and 21b may include a first coil 21a and a second coil 21b.

The insulating film 22 may be formed using a method such as screen printing, a process of exposure and development of photoresist, a spray coating process, or the like.

During, before or after the operation S10 of preparing the coil part 20, an operation S20 of preparing a first magnetic sheet 11′ and a second magnetic sheet 12′ is performed.

The first magnetic sheet 11′ and the second magnetic sheet 12′ may be formed by dispersing a magnetic particle in epoxy resin, or the like, but an exemplary embodiment is not limited thereto.

The magnetic particle may be a ferrite powder or a magnetic metal powder.

The ferrite powder may be formed of Mn—Zn-based ferrite, Ni—Zn-based ferrite, Ni—Zn—Cu-based ferrite, Mn—Mg-based ferrite, Ba-based ferrite, Li-based ferrite, or the like.

The magnetic metal powder may include at least one selected from the group consisting of Fe, Si, Cr, Al, and Ni, and may be, for example, an Fe—Si—B—Cr-based amorphous metal, but an exemplary embodiment is not limited thereto.

A particle diameter of the ferrite powder or the magnetic metal powder may be 0.1 μm to 30 μm.

The first magnetic sheet 11′ and the second magnetic sheet 12′ may be a sheet having good fluidity and low viscosity.

Next, as illustrated in FIG. 6, an operation S30 of filling a portion of the through hole 30′ by pressing the first magnetic sheet 11′ onto the first surface of the coil part 20 is performed. In addition, as illustrated in FIG. 7, an operation S40 of pressing the second magnetic sheet 12′ onto the second surface 2 of the coil part 20 to fill an unfilled region of the through hole 30′ is performed.

In this case, the first magnetic sheet 11′ and the second magnetic sheet 12′ fill the through hole 30′ to form the core 30.

In addition, in a portion of the core 30 in which the first magnetic sheet 11′ is in contact with the second magnetic sheet 12′, a nonmagnetic layer 40 not containing a magnetic particle due to a difference in fluidity between a magnetic particle and resin may be formed therein.

The nonmagnetic layer 40 may indicate a portion without a magnetic particle.

For example, the nonmagnetic layer 40 may be an epoxy layer.

Finally, an operation of forming external electrodes 51 and 52 is performed.

The external electrodes 51 and 52 may be formed in a method such as dipping, sputtering, or the like, but an exemplary embodiment is not limited thereto.

As compared with the case of using a magnetic paste according to the related art, the method of manufacturing an electronic component according to the present exemplary embodiment has the advantages that material costs are low and a process is simple.

However, in the case in which a magnetic sheet is used, when the through hole 30′ is filled, a problem in which filling properties are reduced may occur. In detail, when an aspect ratio of the through hole 30′ is increased, filling properties of the through hole 30′ using a magnetic sheet may be further reduced.

However, in the method of manufacturing a coil component according to the present exemplary embodiment, since the first magnetic sheet 11′ is pressed onto the first surface of the coil part 20 to fill a portion of the through hole 30′ and the second magnetic sheet 12′ is pressed onto the second surface of the coil part 20 to fill an unfilled region of the through hole 30′, filling properties of the through hole 30′ may be improved.

As set forth above, according to an exemplary embodiment, since an electronic component includes a nonmagnetic layer disposed in a core, a rate of change of an inductance value L with respect to current and temperature may be small, thereby maintaining a uniform level of performance.

According to another exemplary embodiment, in a method of manufacturing a coil component, as a through hole having a high aspect ratio is filed with a magnetic particle to form a core, a first magnetic sheet and a second magnetic sheet are pressed onto two surfaces of a coil part, thereby improving a fill factor of a magnetic particle in a through hole. Therefore, a performance of the coil component may be improved.

While exemplary embodiments have been shown and described above, it will be apparent to those skilled in the art that modifications and variations could be made without departing from the scope of the present invention as defined by the appended claims.

What is claimed is:

1. A coil component, comprising:
a coil part having a through hole in a center, including a coil covered by an insulating film, and having a first surface and a second surface opposing each other;
a core disposed in the through hole and including a nonmagnetic layer; and
cover portions disposed on the first surface and the second surface of the coil part.

2. The coil component of claim 1, wherein the nonmagnetic layer is an epoxy layer.

3. The coil component of claim 1, wherein the core includes a first core whose width is gradually narrowed from the first surface of the coil part toward the second surface thereof, and a second core whose width is gradually narrowed from the second surface of the coil part toward the first surface thereof.

4. The coil component of claim 3, wherein the nonmagnetic layer is in contact with the first core and the second core.

5. The coil component of claim 1, wherein the coil includes a first coil and a second coil.

6. The coil component of claim 1, wherein the nonmagnetic layer has a curved or circular shape.

7. A method of manufacturing a coil component, comprising:
preparing a coil part having a through hole in a center, including a coil covered by an insulating film, and having a first surface and a second surface opposing each other;
preparing a first magnetic sheet and a second magnetic sheet containing a magnetic particle;
pressing the first magnetic sheet onto the first surface of the coil part to fill a portion of the through hole; and
pressing the second magnetic sheet onto the second surface of the coil part to fill an unfilled region of the through hole.

8. The method of manufacturing a coil component of claim 7, wherein a core is formed by the first magnetic sheet and the second magnetic sheet filling the through hole.

9. The method of manufacturing a coil component of claim 8, wherein a nonmagnetic layer not containing a magnetic particle is disposed in the core, and the nonmagnetic layer is in contact with the first magnetic sheet and the second magnetic sheet.

10. The method of manufacturing a coil component of claim 9, wherein the nonmagnetic layer is an epoxy layer.

11. The method of manufacturing a coil component of claim 7, wherein the through hole is formed by contacting a first through hole whose width is gradually narrowed from a first surface toward a center to a second through hole whose width is gradually narrowed from a second surface toward the center.

12. The method of manufacturing a coil component of claim 11, wherein a nonmagnetic layer not containing a magnetic particle is disposed in the through hole, and the nonmagnetic layer is in contact with the first magnetic sheet and the second magnetic sheet.

13. The method of manufacturing a coil component of claim 7, wherein the coil includes a first coil and a second coil.

14. A coil component, comprising:
a coil part having a through hole in a center, including a coil covered by an insulating film, and having a first surface and a second surface opposing each other; and
a core disposed in the through hole and including a nonmagnetic layer,
wherein the core includes portions of first and second magnetic sheets that are separated by a nonmagnetic layer.

15. The coil component of claim 14, wherein the nonmagnetic layer has a curved or circular shape.

16. The coil component of claim 14, wherein the nonmagnetic layer is an epoxy layer.
